(19) United States
(12) Patent Application Publication
(10) Pub. No.: US 2016/0064850 A1
(43) Pub. Date: Mar. 3, 2016

(54) APPARATUS FOR COVERING ELECTRICAL PLUGS

(71) Applicants: Robert John Draper, JR., Roswell, GA (US); Alcory Jermaine Chisolm, Kennesaw, GA (US)

(72) Inventors: Robert John Draper, JR., Roswell, GA (US); Alcory Jermaine Chisolm, Kennesaw, GA (US)

(21) Appl. No.: 14/470,825

(22) Filed: Aug. 27, 2014

(51) Int. Cl. H01R 13/516; H01R 13/62; H01R 13/44

(52) U.S. Cl. CPC H01R 13/516; H01R 13/44; H01R 13/62

(57) ABSTRACT

An apparatus comprises a cover configured to enclose at least a body of an electrical power plug. The electrical power plug is configured with prongs. The prongs are configured to be received by a wall outlet. The cover comprises a first opening configured to pass of a cord from the electrical power plug, and a second opening configured to expose the prongs. The second opening is larger than the first opening, wherein the cover engages a back lip of the electrical power plug.

### CROSS-REFERENCE TO RELATED APPLICATIONS

Not applicable.

### RELATED CO-PENDING U.S. PATENT APPLICATIONS

Not applicable

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to protective coverings. More particularly, the invention relates to protective coverings for electrical plugs.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

In many instances, exposed prongs of electrical plugs may present a danger of electrical shock and/or be easily damaged.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. One such aspect of the prior art teaches of a shield which is in the form of bellows that is able to expand and collapse. By way of educational background, another aspect of the prior art generally useful to be aware of teaches of a safety device for preventing accidental contact of a user's fingers with the live blades of an electrical plug during inserting or removal of the plug from a wall socket and a method for attaching the safety device to an electrical plug. However, these solutions may not provide an effective means of covering prongs so as to protect the prongs and/or users. A solution which did so would be desirable.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustration of an exemplary cover for electrical plugs, in which FIG. 1A, FIG. 1B, and FIG. 1C provide multiple views, in accordance with an embodiment of the present invention;

FIG. 2 is an illustration of an exemplary electrical plug, in which FIG. 2A is an electrical plug without a cover and FIG. 2B is an electrical plug with a cover, in accordance with an embodiment of the present invention;

FIG. 3 is an illustration of an exemplary cover showing exemplary measurements, in which FIG. 3A is a top view and FIG. 3B is a side view, in accordance with an embodiment of the present invention;

FIG. 4 is an illustration of an exemplary cover on an electrical plug, in accordance with an embodiment of the present invention;

FIG. 5 is an illustration of exemplary covers of various colors, in accordance with an embodiment of the present invention.

FIG. 6 is an illustration of an exemplary cover for electrical plugs, in which FIG. 6A is a top view, FIG. 6B is a side view, and FIG. 6C is an internal plate, in accordance with an embodiment of the present invention;

FIG. 7 is an illustration of an exemplary cover for multiple electrical plugs, in which FIG. 7A is side view and FIG. 7B is front view, in accordance with an embodiment of the present invention;

FIG. 8 is an illustration of an exemplary cover for multiple electrical plugs, in which FIG. 8A is a perspective view, and FIG. 8B and FIG. 8C are front views, in accordance with an embodiment of the present invention; and

FIG. 9 is an illustration of multiple views of an exemplary cover for electrical plugs, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Some embodiments of the present invention may provide means and/or methods for protecting electrical prongs from damage and/or protecting people, animals and/or property from injury caused by electrical current.

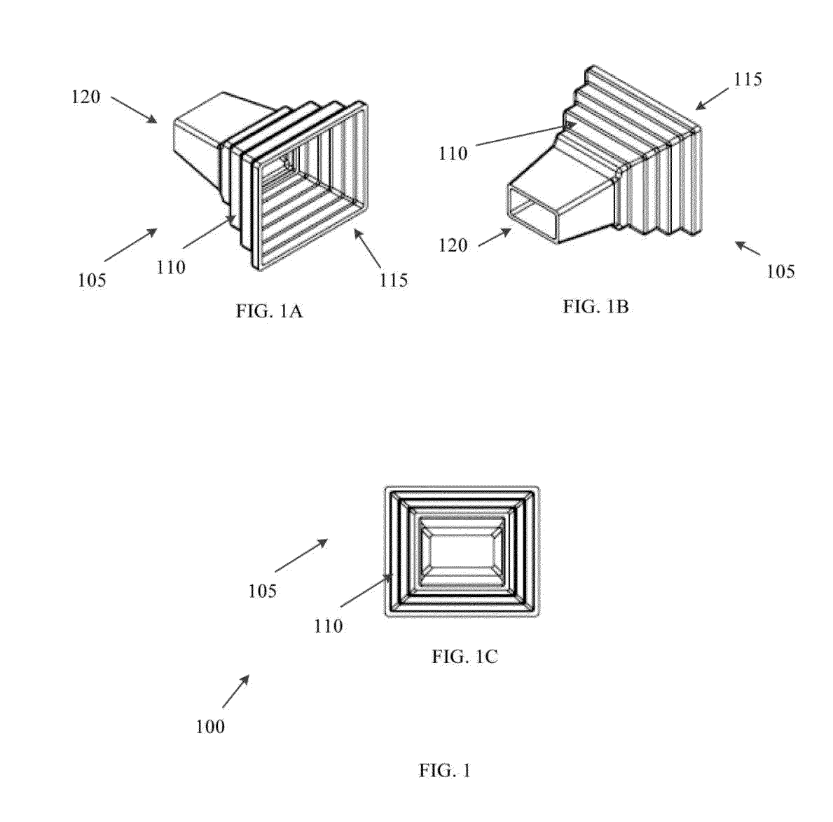

FIG. 1 is an illustration of an exemplary cover for electrical plugs, in which FIG. 1A, FIG. 1B, and FIG. 1C provide multiple views, in accordance with an embodiment of the present invention. In the present embodiment, a cover 105 may be designed to fit over an electrical plug. In some embodiments, cover 105 may be composed of any suitable material, including, without limitation, rubber, plastic, PVC, silicone, polymer compounds, and others. In the present embodiment, cover 105 may have a rectangular shape. In alternative embodiments, cover 105 may have any shape suitable to fit over a variety of plug sizes and/or shapes, including, without limitation, circular, ovular, and various free-form shapes. In a non-limiting example, a cover 105 may be a suitable shape and/or size to fit over a three-prong electrical plug. In the present embodiment, cover 105 may have a shroud 110 portion. In some embodiments, shroud 110 may have a telescoping design, and a first open end 115 of the cover 105 may be larger than a second open end 120. In some embodiments, shroud 110 may have a retractable more rigid design that slides over the plug, or individual prongs. In the present embodiment, shroud 110 may telescope in a step-wise fashion. In alternative embodiments, shroud 110 may telescope in a uniform fashion.

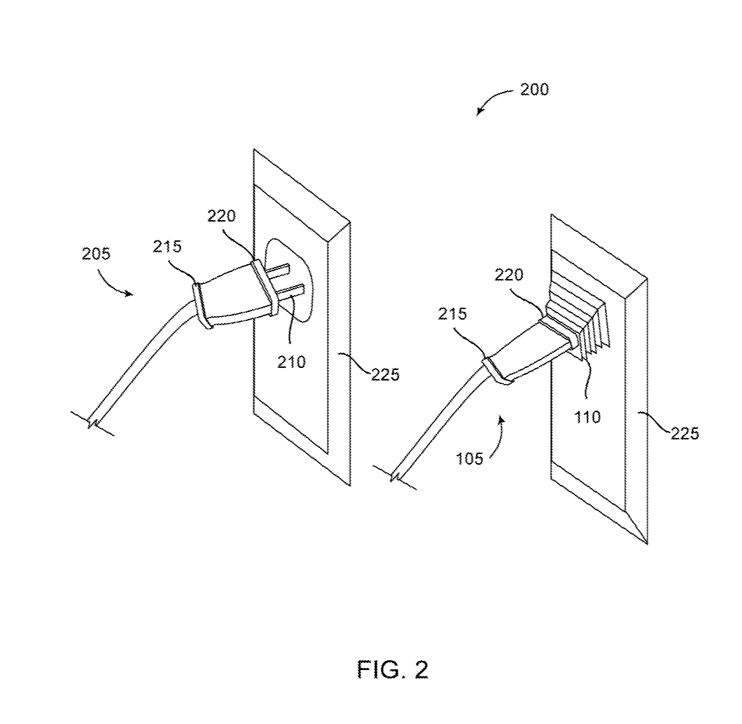

FIG. 2 is an illustration of an exemplary electrical plug, in which FIG. 2A is an electrical plug without a cover and FIG. 2B is an electrical plug with a cover, in accordance with an embodiment of the present invention. In the present embodiment, an electrical plug 205 may be suitable to receive a cover 105. In some embodiments, cover 105 may be suitable to cover exposed prongs 210 of electrical plug 205 to prevent damage from touching of exposed prongs 210 by people, animals, or things. In the present embodiment, cover 105 may have a retractable shroud 110. In some embodiments, shroud 110 design may allow it to retract over itself when pushed against a wall or other surface. In many embodiments, retraction of shroud 110 may allow cover to maintain contact against wall or other surface and/or may minimize spring-like force pulling electrical plug away from wall or other surface. The shroud or cover 110 may provide a minimal amount of force against the wall plate or plug, and will allow a plug to stay in proper place in a well functioning environment. In situations where a plug or wall socket will not allow for a proper and tight fit, the pressure from the shield will prevent an improper fitting plug from staying live and connected to a socket. In some embodiments, cover 105 may attach to any portion of an electrical plug 205. In the present embodiment, cover 105 may attach to a front and/or back lip or “positive locks” 215 of plug 205. In other embodiments, cover 105 may attach to a front lip 220 of plug 205. In alternative embodiments, edges of first open end 115 may attach to hooks or other attaching means which may be placed on electrical outlet surface 225. In other alternative embodiments, edges of first open end 115 may attach to electrical outlet surface 225 by means of an adhesive, magnets, screws, or other suitable means.

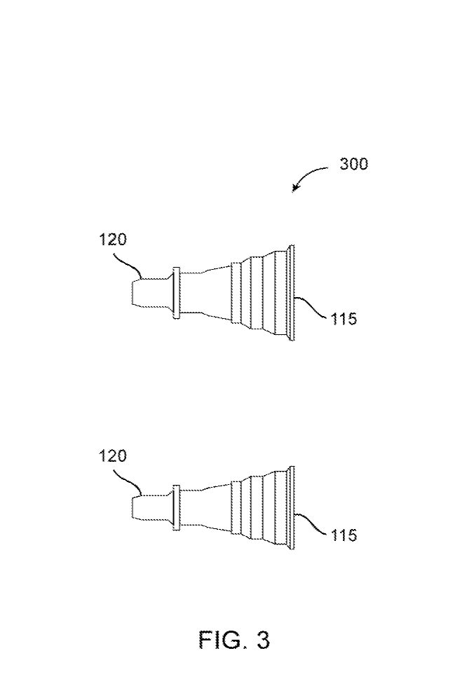

FIG. 3 is an illustration of an exemplary cover showing exemplary measurements, in which FIG. 3A is a top view and FIG. 3B is a side view, in accordance with an embodiment of the present invention. Embodiments of the present invention may be a variety of sizes to accommodate electrical plugs 205 of various sizes. In the present embodiment, a first open end 115 may have a width of 3.5 cm and a height of 3.2 cm. Further, in the present embodiment, a second open end 120 may have a width of 10 mm and a height of 6 mm.

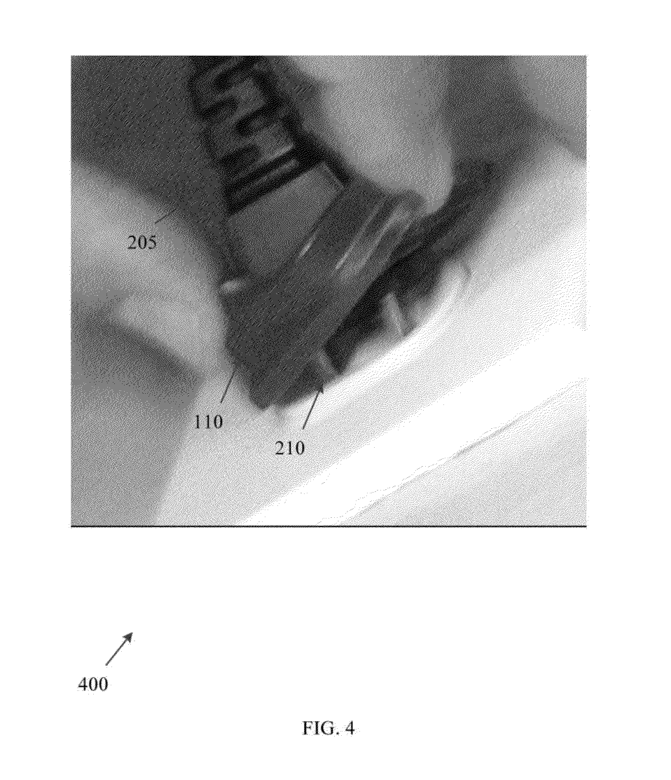

FIG. 4 is an illustration of an exemplary cover on an electrical plug, in accordance with an embodiment of the present invention. In the present embodiment, shroud 110 may be suitable to retract while electrical plug 205 is fully plugged in and shroud 110 may extend to maintain contact with wall or other surface when prongs 210 are exposed.

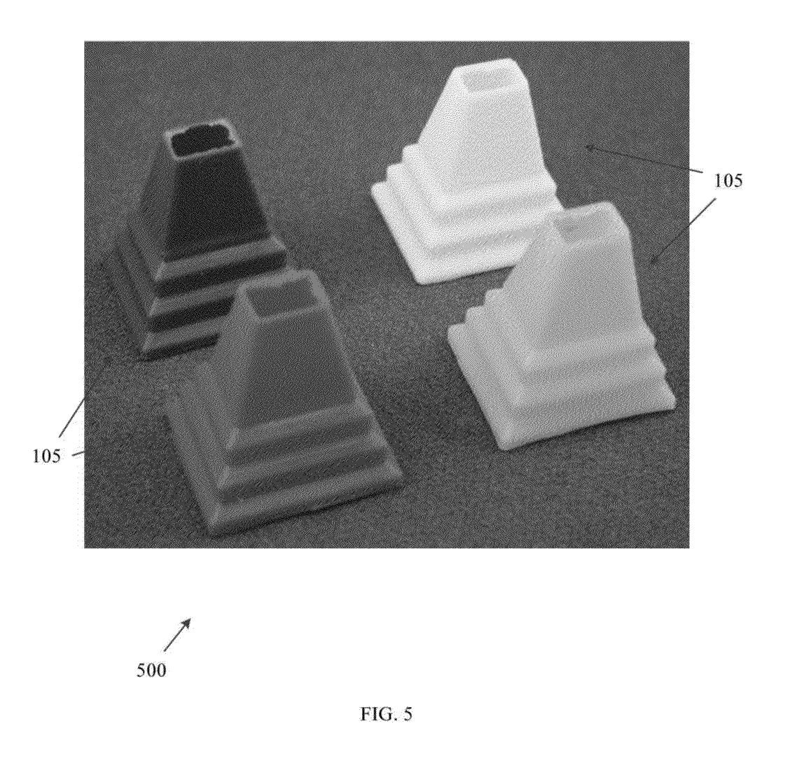

FIG. 5 is an illustration of exemplary covers of various colors, in accordance with an embodiment of the present invention. In the present embodiment, covers 105 may any color. In some alternative embodiments, covers 105 may be personalized to have any design and/or markings. In a non-limiting example, a cover 105 may have a “wooden” appearance. In other alternative embodiments, covers 105 may be clear.

Many embodiments may provide cosmetic appeal to electric plugs 205 as well as increased safety. At least one embodiment may be suitable for any plug 205. Some embodiments may provide protection for prongs 210 when an electrical plug 205 is not plugged in. In a non-limiting example, an embodiment may provide protection for prongs 210 in an event in which a person steps on an electrical plug 205 lying on a floor.

Some embodiments may be composed of a single piece. Other embodiments may have multiple components which may fit together, and possibly utilize pieces that attach directly to the wall plate using, screws, adhesive, suction or magnets.

In some embodiments, users may turn the shroud inside out, to create a “funnel” shape that allows the shroud to be easily placed 110 backwards onto an electrical plug 205 and the shroud 110 may then be turned right side up and pulled back over a back lip (positive lock) 215 and then pulled forward to lock a second open end 120 onto the back lip (positive lock) 215.

In some alternative embodiments, cover 105 may attach to electrical outlet surface 225 and may be sized to be suitable to receive an electric plug 205. In some of these alternative embodiments, cover 105 may be suitable for permanent attachment to electrical outlet surface 225.

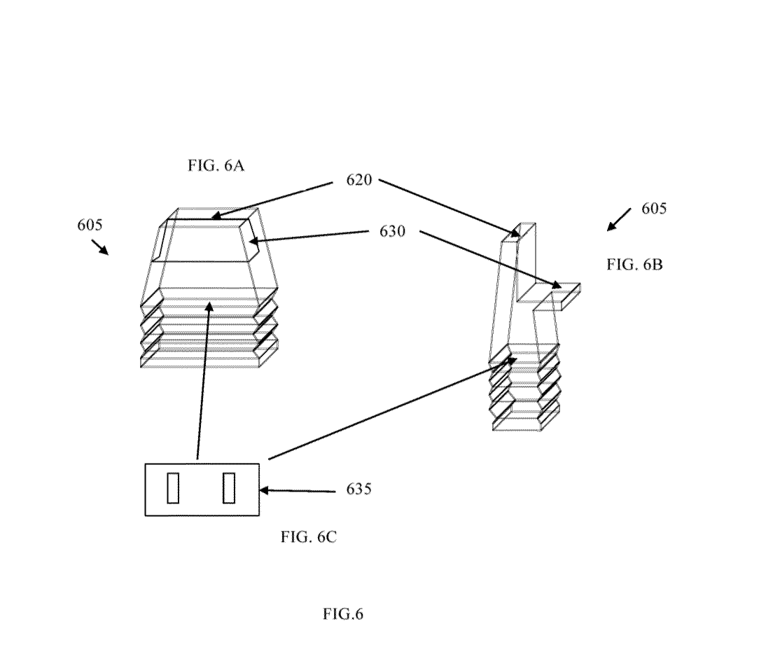

FIG. 6 is an illustration of an exemplary cover for electrical plugs, in which FIG. 6A is a top view, FIG. 6B is a side view, and FIG. 6C is an internal plate, in accordance with an embodiment of the present invention. In the present embodiment, a cover 605 may be designed to fit over an electrical plug. In some embodiments, cover 605 may be composed of any suitable material, including, without limitation, rubber, plastic, PVC, silicone, and polymer compounds. In the present embodiment, cover 605 may have a rectangular shape. In alternative embodiments, cover 605 may have any shape suitable to fit over a variety of plug sizes and/or shapes, including, without limitation, circular, ovular, and various free-form shapes. In a non-limiting example, a cover 605 may be a suitable shape and/or size to fit over a three-prong electrical plug. In the present embodiment, cover 605 may have a movable access portion 630. In FIG. 6B, access portion 603 is shown in an open position. In this position a user may insert an electrical plug (not shown) into cover 605 with the cord of the electrical plug placed in opening 620. With the electrical plug and cord in place, the user may place the access portion 630 in a closed position shown in FIG. 6A. In some embodiments, access portion 630 may hinged to cover 605. In some other embodiments, access portion 630 may be configured as a removable piece. Thin plate 635 is positioned internal to cover 605 to prevent the electrical plug from moving out of cover 605.

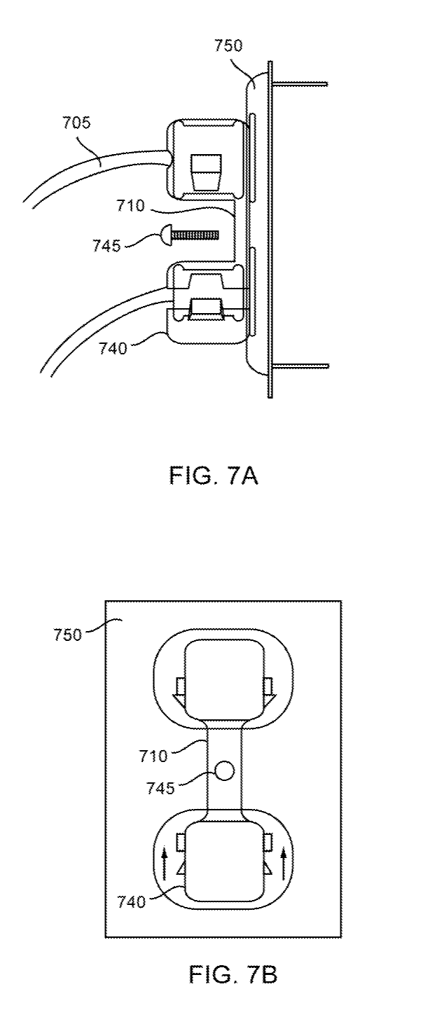

FIG. 7 is an illustration of an exemplary cover for multiple electrical plugs, in which FIG. 7A is side view and FIG. 7B is front view, in accordance with an embodiment of the present invention. In the present embodiment, cover 710 is attached to faceplate 750 with faceplate screw 745. With cover 710 attached to faceplate 750, a user may remove access portion 740 to place electrical plug 705 into cover 710 with electrical plug 705 plugged into an electrical outlet. With electrical plug 705 in place, access portion 740 may be reattached to secure electrical plug 705 and prevent accidental removal of electrical plug 705 from the electrical outlet.

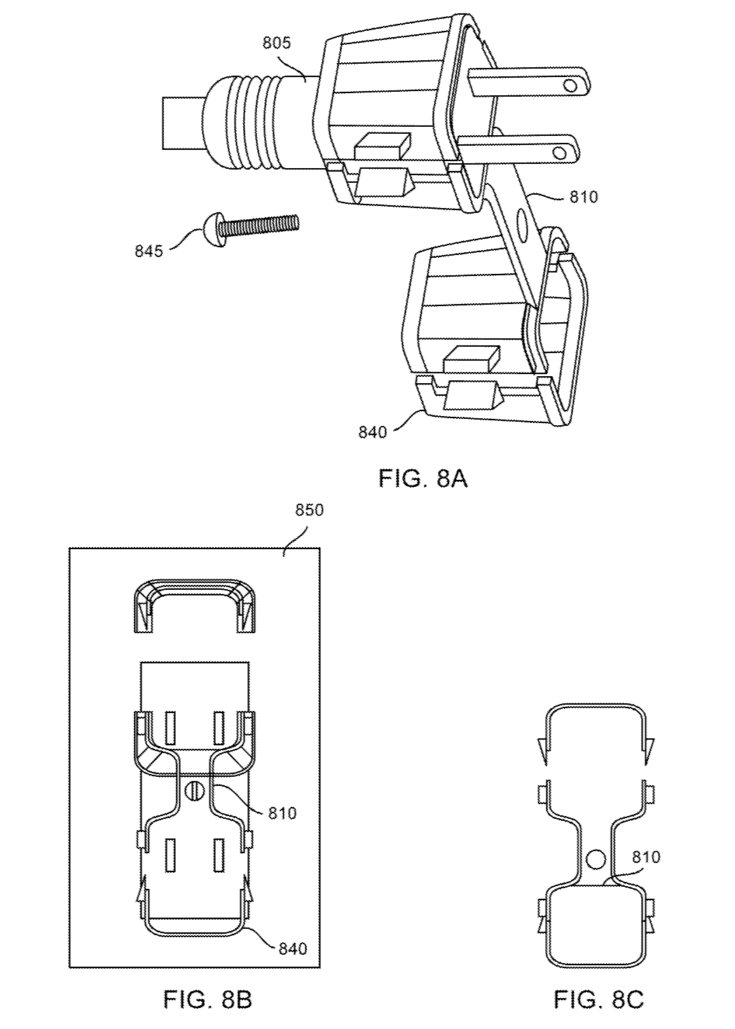

FIG. 8 is an illustration of an exemplary cover for multiple electrical plugs, in which FIG. 8A is a perspective view, and FIG. 8B and FIG. 8C are front views, in accordance with an embodiment of the present invention. In the present embodiment, cover 810 is attached to faceplate 850 with faceplate screw 845. With cover 810 attached to faceplate 850, a user may remove access portion 840 to place electrical plug 805 into cover 810 with electrical plug 805 plugged into an electrical outlet. With electrical plug 805 in place, access portion 840 may be reattached to secure electrical plug 805 and prevent accidental removal of electrical plug 805 from the electrical outlet. In some embodiments, the user may secure electrical plug 805 in cover 810 before attaching cover 801 to faceplate 850. In some embodiments, access portion may hinged to cover 810.

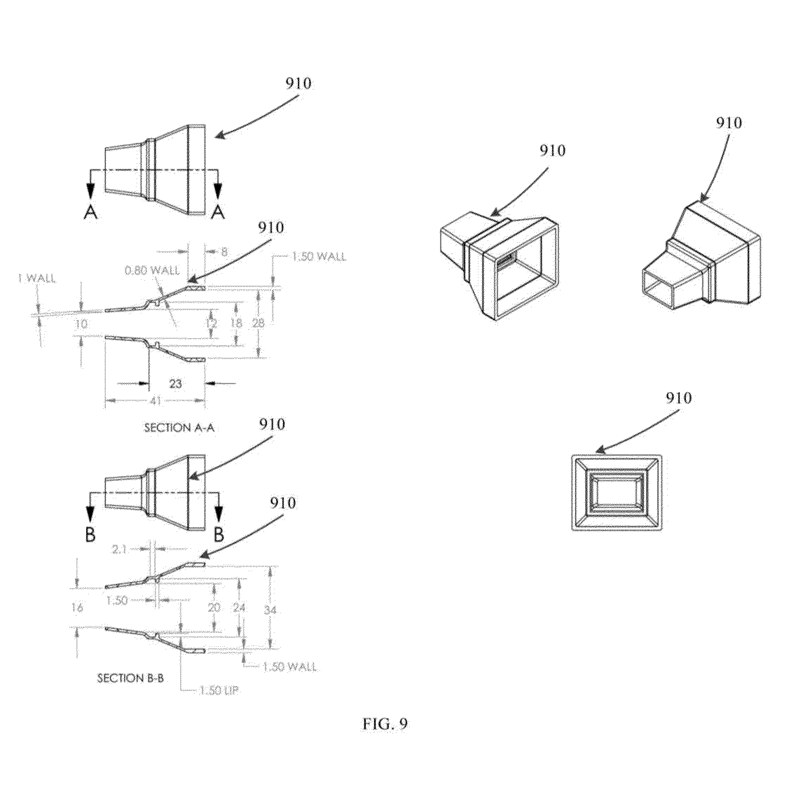

FIG. 9 is an illustration of multiple views of an exemplary cover for electrical plugs, in accordance with an embodiment of the present invention. In the present embodiment, a cover 910 may be designed to fit over an electrical plug. In some embodiments, cover 910 may be composed of any suitable material, including, without limitation, rubber, plastic, PVC, silicone, polymer compounds, and others. In the present embodiment, cover 910 may have a rectangular shape. In alternative embodiments, cover 910 may have any shape suitable to fit over a variety of plug sizes and/or shapes, including, without limitation, circular, ovular, and various free-form shapes. In a non-limiting example, a cover 910 may be a suitable shape and/or size to fit over a three-prong electrical plug.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing protective coverings according to the present invention will be apparent to those skilled in the art. Various aspects of the invention have been described above by way of illustration, and the specific embodiments disclosed are not intended to limit the invention to the particular forms disclosed. The particular implementation of the protective coverings may vary depending upon the particular context or application. By way of example, and not limitation, the protective coverings described in the foregoing were principally directed to electrical plug implementations; however, similar techniques may instead be applied to any devices which may carry electrical charge, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus comprising:
a cover being configured to enclose at least a body of an electrical power plug, the electrical power plug being configured with prongs, the prongs being configured to be received by a wall outlet, said cover comprising a first opening being configured to pass of a cord from the electrical power plug, and a second opening being configured to expose the prongs, said second opening being larger than said first opening, wherein said cover engages a back lip of the electrical power plug.

2. The apparatus as recited in claim 1, in which said cover further comprises a shroud portion being configured to surround the prongs, said shroud portion further being configured to telescope back from the prongs during insertion of the prongs into the wall outlet and to telescope forward during removal of the prongs from the wall outlet.

3. The apparatus as recited in claim 2, in which said shroud portion shields the prongs during the removal.

4. The apparatus as recited in claim 2, in which said shroud portion further comprises a plurality of segments of increasing diameter.

5. The apparatus as recited in claim 2, in which said cover is further configured to be turned inside out, to enable said cover to be easily placed backwards onto the electrical power plug.

6. The apparatus as recited in claim 1, in which said cover further comprises a movable access portion for enabling placement of the electrical power plug into said cover.

7. The apparatus as recited in claim 6, further comprising a thin plate for mitigating movement of the electrical plug out of said cover.

8. The apparatus as recited in claim 1, in which said cover is further configured for joining to the wall outlet.

9. The apparatus as recited in claim 8, in which said cover is joined to a faceplate of the wall outlet.

10. The apparatus as recited in claim 9, in which a faceplate screw of the faceplate attaches said cover to the faceplate.

11. The apparatus as recited in claim 1, in which said cover is further configured to enclose at least bodies of two electrical power plugs.

12. The apparatus as recited in claim 11, in which said cover further comprises an access portion for each of the two electrical power plugs.

13. The apparatus as recited in claim 12, in which said access portion is removable.

14. The apparatus as recited in claim 1, in which the electrical power plug is configured with three prongs.

15. An apparatus comprising:
means for enclosing at least a body of an electrical power plug, the electrical power plug being configured with prongs, the prongs being configured to be received by a wall outlet, wherein said enclosing means engages a back lip of the electrical power plug.

16. The apparatus as recited in claim 15, further comprising means for telescoping back from the prongs during insertion of the prongs into the wall outlet and for telescoping forward during removal of the prongs from the wall outlet.

17. The apparatus as recited in claim 15, further comprising means for mitigating movement of the electrical plug out of said enclosing means.

18. The apparatus as recited in claim 15, further comprising means for joining to the wall outlet.

19. An apparatus comprising:
a cover being configured to enclose at least a body of an electrical power plug, the electrical power plug being configured with prongs, the prongs being configured to be received by a wall outlet, said cover comprising a first opening being configured to pass of a cord from the electrical power plug, and a second opening being configured to expose the prongs, said second opening being larger than said first opening, said cover further comprising a shroud portion having a plurality of segments of increasing diameter and being configured to surround the prongs, said shroud portion further being configured to telescope back from the prongs during insertion of the prongs into the wall outlet and to telescope forward to shield the prongs during removal of the prongs from the wall outlet, said cover further comprising an elastic material and is further configured to be turned inside out to enable said cover to be easily placed backwards onto the electrical power plug, wherein said cover engages a back lip of the electrical power plug.

20. The apparatus as recited in claim 19, in which the electrical power plug is configured with three prongs.
